(19) United States
(12) Patent Application Publication
(10) Pub. No.: US 2015/0251883 A1
(43) Pub. Date: Sep. 10, 2015

(54) Automotive Hydraulic Tilt Lift Assembly and Related Methods

(71) Applicant: Arnaldo Miranda, Coral Gables, FL (US)

(72) Inventor: Arnaldo Miranda, Coral Gables, FL (US)

(21) Appl. No.: 14/202,408

(22) Filed: Mar. 10, 2014

(51) Int. Cl. B66F 3/24; B66F 7/22

(52) U.S. Cl. CPC B66F 3/24; B66F 7/22

(57) ABSTRACT

The invention is directed towards a hydraulic tilt lift assembly for raising and rotating an automobile which includes a first vertical column and second vertical column affixed to a garage floor. Each vertical column has a shaft, a middle portion and a rotation cavity positioned proximate to the middle portion. Perpendicularly attached to the middle portion of each vertical column is a pivot fork which includes a first holding beam and second holding beam in parallel relation to one another. A connecting beam (perpendicular to the first and second holding beams) attaches to both holding beams. In turn, the connecting beam connects to the rotation cavity of the vertical column through a rotating beam. A first fastener is positioned on the first holding beam, while a second fastener is positioned on the second holding beam. Both fasteners may include parallel engaging bars sufficient to engage one tire of the automobile.

### FIELD OF THE INVENTION

The present invention relates to the field of hydraulic lift assemblies, and, more particularly, to an automotive hydraulic lift assembly for lifting, rotating and pivoting an automobile about an axis.

### BACKGROUND

In order to properly service and maintain automobiles, a variety of mechanical jacks have been developed over the years. Each jack is designed based upon the underlying purpose and function of the need to lift and reposition the automobile. There are three common types of mechanical jacks: car jacks, floor jacks and garage jacks. One form of powerful garage jack is a hydraulic jack, which employs hydraulic power to lift the automobile to a greater vertical distance above the garage floor.

Hydraulic jacks are typically used for shop work by automotive professionals, such as mechanics and service technicians. Most hydraulic jacks are not designed for specific vehicle requirements, but are designed for common automotive designs. In their most simplified form, the hydraulic jack uses an incompressible fluid that forces a cylinder via a pump plunger. When the plunger pulls back, it draws hydraulic fluid out of a reservoir through a suction check valve into the pump chamber. When the plunger moves forward, it pushes the fluid through a discharge check valve into the cylinder, thus casing the cylinder to rise.

Current hydraulic jacks allow for a variety of automobiles to be vertically lifted several feet above the garage floor for indefinite periods of time to allow visual inspection and access to the underbelly of the automobile. However, current hydraulic jacks are limited in their range of motion.

### SUMMARY OF THE INVENTION

The present invention solves many of the limitations of current hydraulic lift assemblies used to raise automobiles for inspection and repair. Moreover, the invention allows for not only the lifting of the automobile but also the rotating of the automobile perpendicularly in relation to both axles. This hydraulic tilt lift assembly includes a first vertical column and second vertical column that rest on the garage floor. Each vertical column has a rigid shaft, a middle portion and a rotation cavity positioned proximate to the middle portion.

Perpendicularly attached to the middle portion of each vertical column is a pivot fork. Each pivot fork includes a first holding beam and second holding beam in parallel relation to one another. A connecting beam (perpendicular to both the first and second holding beams) attaches to both holding beams. In turn, the connecting beam connects to the rotation cavity of the vertical column through a rotating beam. A first fastener is positioned on the first holding beam, while a second fastener is positioned on the second holding beam. Both fasteners may include parallel engaging bars sufficient to engage one tire of the automobile. Optionally, each fastener can include a “Y” tether, having a first tether portion and a second tether portion sufficient to secure each tire of the automobile onto both parallel engaging bars.

The invention further includes a hydraulic pump, which employs hydraulic fluid to both lift and tilt the automobile through use of the pivot fork. Connected to the middle portion of each vertical column, each hydraulic pump includes an outer cylinder filled with hydraulic fluid, a piston positioned within the outer cylinder, a first fluid disbursement tube, and a second fluid disbursement tube. Here, the first fluid disbursement tube supplies a sufficient amount of hydraulic fluid to vertically raise and lower the pivot fork, while the second fluid disbursement tube pivots the pivot fork either clockwise or counterclockwise about the vertical column.

The invention is further directed to a method of lifting and then tilting an automobile about a garage floor. The method starts with the step of vertically raising a pivot fork about a vertical column having a shaft, middle portion and a rotation cavity proximate to the middle portion. Here, each pivot fork includes a first holding beam and corresponding second holding beam in parallel relationship to one another. Each pivot fork may further include a connecting beam which attaches the first holding beam to the second holding beam, wherein the connecting beam connects to the vertical column through a rotating beam positioned within the rotation cavity. The second step includes rotating the rotating beam of the pivot fork either clockwise or counterclockwise about the rotation cavity of the vertical column through a hydraulic pump capable of inserting or retracting hydraulic fluid to effectuate rotation.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a front view of the lift assembly including the first vertical carriage and the second vertical carriage.

FIG. 2 is a front view of the lift assembly showing the proper fastening of an automobile onto each rotatable fork.

FIG. 3 is a side view of the lift assembly.

FIG. 4 is a side view of the lift assembly showing one way to affix a vertical column to the garage floor.

FIG. 5 is a side view of the lift assembly showing the horizontal stabilizing bar.

FIG. 6A is a perspective view of the positioning vehicle when an automobile is not resting on the lift assembly.

FIG. 6B is a perspective view of the positioning vehicle when an automobile is resting on the lift assembly.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

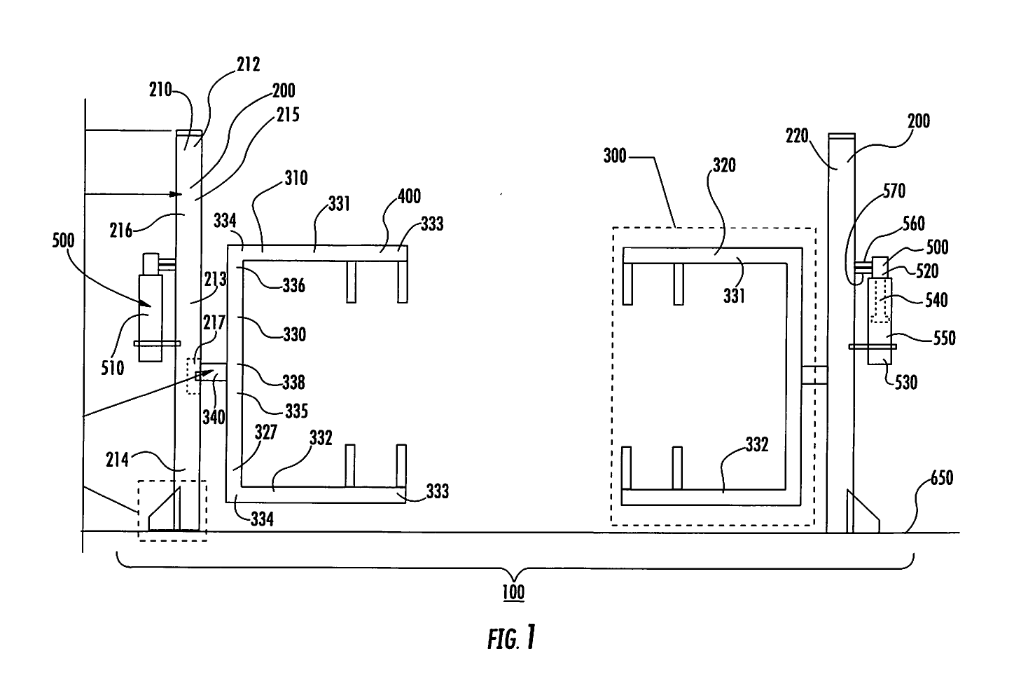

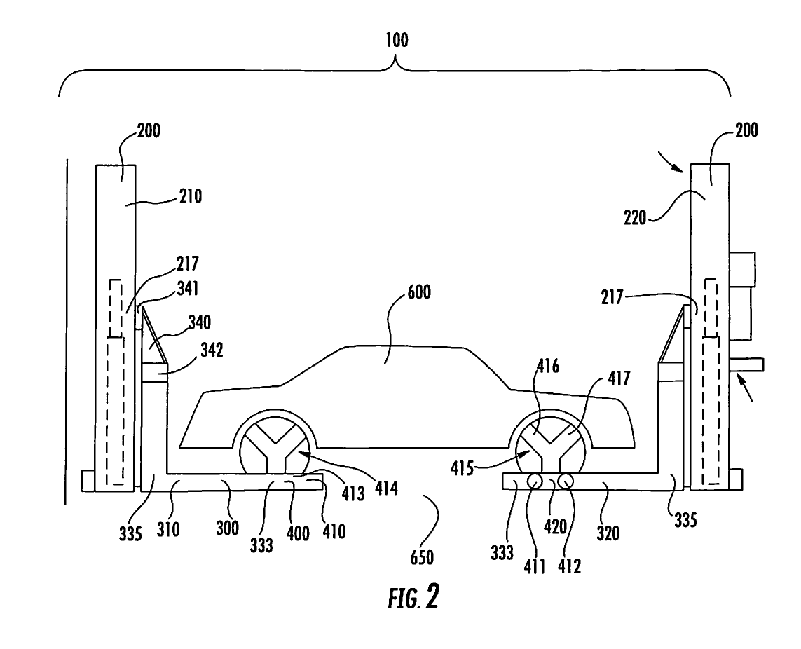

FIG. 1 and FIG. 2 both illustrate, by way of example, the salient components of a tilt lift assembly 100. First turning to FIG. 1, the primary components include two vertical columns 200, two or more pivot forks 300, a plurality of fasteners 400, and hydraulic chambers 500.

### The Vertical Column

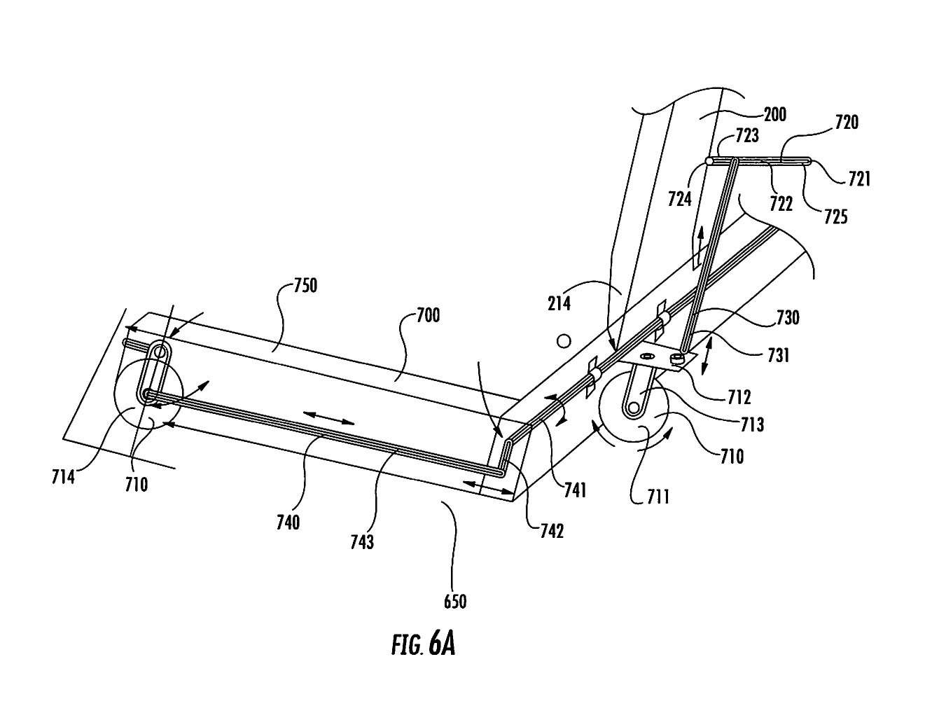

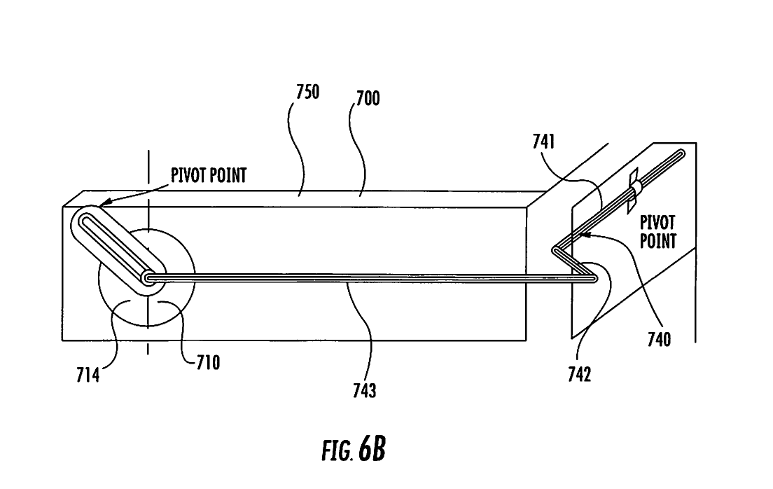

Preferably, each tilt lift assembly 100 includes two vertical columns 200 in order to effectively lift an automobile 600 (shown in FIG. 2) above the garage floor 650. More specifically, the tilt lift assembly 100 includes a first vertical column 210 and a corresponding second vertical column 220. The second vertical column 220 mirrors the size, dimension and overall structure of the first vertical column 210. While each vertical column 200 can be manufactured from a variety of strong, resilient and non-corrosive materials, it is preferably made of steel. While each vertical column 200 can be directly attached to the garage floor 650, they can also be attached to a positioning vehicle 700 having a plurality of spring loaded wheels 710 (as illustrated in FIG. 6A and FIG. 6B and described herein). Upon positioning of an automobile onto a vertical column 200, the depression of the spring loaded wheels causes the positioning vehicle 700 to rest on the garage floor 650 and become immobile.

As further shown in FIG. 1, the first vertical column 210 includes a rigid shaft 211 having a top end 212, a middle portion 213, and a corresponding bottom end 214. Moreover, the rigid shaft 211 also includes a front side 215 and corresponding back side 216. The vertical column 210 is essentially circular in cross section. However, the cross section can be any essentially sturdy design to ensure rigidity.

Positioned on the front side 215 of the rigid shaft 211 proximate to the middle portion 213 is a rotation cavity 217. However, such rotation cavity 217 can be located along any portion of the front side 211 of the first vertical column 210. The rotation cavity 217 is in direct communication with a hydraulic chamber 500 (described in greater detail below). Moreover, the rotation cavity 217 is of a sufficient size and dimension to receive, hold and maintain a pivot fork 300.

### The Pivot Fork

Apart from both vertical columns 200, the invention is further directed to two pivot forks 300. More specifically, the invention teaches a first pivot fork 310 and a corresponding second pivot fork 320. Preferably, the second pivot fork 320 mirrors the size, dimension and overall structure of the first pivot fork 310. The function of the pivot forks 300 is to both vertically lift an automobile 600 (shown in FIG. 2) above the garage floor 650 as well as rotate the automobile 600 up to 90 degrees clockwise (or counterclockwise) in relation to both vertical columns 200.

Although the pivot fork 300 can take a variety of forms and possesses various functionality, FIG. 1 offers one preferred structure and assembly. As shown, each pivot fork 300 preferably includes four rigid fork beams 330. More specifically, a pivot fork 300 includes a first holding beam 331 and a corresponding second holding beam 332. Both the first holding beam 331 and second holding beam 332 have the same length and are preferably parallel to one another. Moreover, each holding beam (331 and 332) has a first end 333 and corresponding second end 334.

The second end 334 of both the first holding beam 331 and second holding beam 332 connects with a perpendicular positioning beam 335. The positioning beam 335 includes a first end 336, a corresponding second end 337 and a middle section 338. Accordingly, the first end 336 connects to the second end 334 of the first holding beam 331. Likewise, the second end 337 connects to the second end 334 of the second holding beam 332.

Attached to the middle section 338 of the positioning beam 335 is a rotating beam 340. The rotating beam 340 is parallel, along a horizontal plane, to both holding beams (331 and 332) as well as perpendicular to the positioning beam 335. A portion of the rotating beam 340 is inserted within the rotation cavity 217.

As shown in FIG. 2, the rotating beam 340 can include multiple components. More specifically, the rotating beam 340 not only includes an insert 341 positioned within the rotation cavity 217 but also a vertical connector 342.

The vertical connector 342 connects the insert 341 with the positioning beam 335. However, the function of the vertical connector 342 allows each pivoting fork 300 to function (move vertically about the garage floor 650 as well as rotate about each vertical column 200) without any need to move the vertical columns 200 within the garage floor 650. Put another way, the overall design of the tilt lift assembly 100, when including use of the vertical connector 342, reduces the need for the vertical column 200 to move into (and out of) the garage floor 650 when elevating (and alternatively lowering) the automobile 600.

### The Fasteners

Both FIG. 1 and FIG. 2 illustrate, by way of example, one embodiment of the fasteners 400. First turning to FIG. 1, the tilt lift assembly 100 preferably includes four fasteners 400—to correspond with the four tires found on most commercial automobiles 600 (shown in FIG. 2). Each pivot fork 300 includes two fasteners 400—a first fastener 410 and corresponding second fastener 420. As further shown, the first fastener 410 is positioned at the first end 333 of the first holding beam 331. Likewise, the second fastener 420 is located at the first end 333 of the second holding beam 332.

FIG. 1 illustrates, by way of example, how the first fastener 410 can include a first engaging bar 411 and a corresponding second engaging bar 412. Both engaging bars 411 and 412 are parallel to one another and spaced sufficiently to contact the tire of an automobile 600 (shown in FIG. 2). Moreover, both engaging bars 411 and 412 are perpendicular with the first holding bar 331. It is important to note that both engaging bars 411 and 412 only provide a bottom affixing surface 413 for the first fastener 410.

While both engaging bars 411 and 412 allow for a bottom affixing surface 413, FIG. 2 illustrates the top affixing surface 414 for each fastener 400. Although the invention contemplates several forms of top affixing surfaces 414, FIG. 2 specifically illustrates use of a tether 415. While many tether 415 structures can be used, the invention specifically contemplates a “Y” tether 415, such that the top of the tire includes a first tether portion 416 and second portion 417 to stabilizing the automobile 600 onto both engaging bars 411 and 412. Put another way, the “Y” tether 415 compacts the tire onto both engaging bars 411 and 412.

Employing these tethers 415 to connect each tire to the engaging bars 412 and 412 located at each of the four fasteners 400 helps ensure that the automobile 600 is maintained on both pivot forks 300 while being rotated about both vertical columns 200 during use of the lilt lift assembly 100.

### The Hydraulic Pump

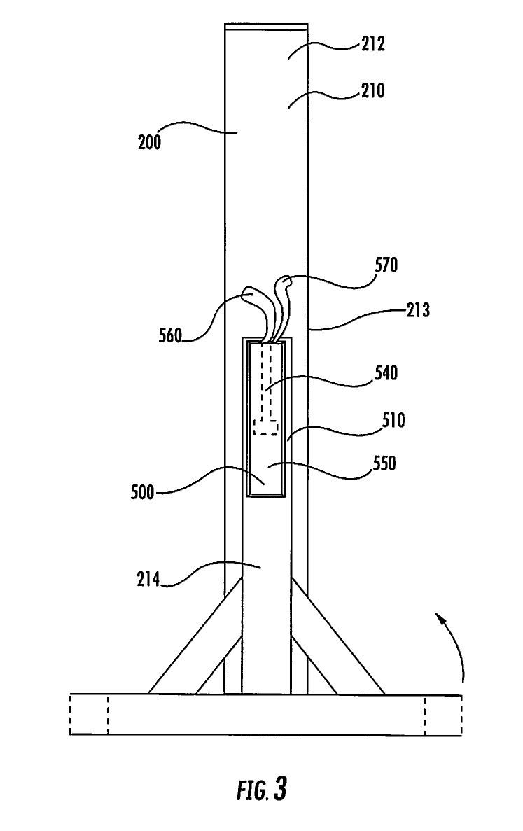

Both FIG. 1 and FIG. 3 illustrate the positioning and function of each hydraulic pump 500. There are at least two hydraulic pumps 500: a first hydraulic pump 510 and corresponding second hydraulic pump 520. The first hydraulic pump 510 attaches to the first vertical cylinder 210, which then powers the first pivot fork 310. Likewise, the second hydraulic pump 520 attaches to the second vertical cylinder 220 to operate the second pivot fork 320. Alternatively, a single hydraulic pump 500 can power both vertical cylinders 200.

Although each hydraulic pump 500 can take a variety of known forms and structures, they primarily include an outer cylinder 530, a piston 540, hydraulic fluid 550, a first fluid disbursement tube 560 and a second fluid disbursement tube 570. Here, based upon driving the piston 540 within the cylinder 530, hydraulic fluid 550 is squeezed out of the first fluid disbursement tube 560 which helps vertically raise and lower the first pivot fork 310 in relation to the garage floor 650.

Alternatively, displacement of hydraulic fluid 550 within the second fluid disbursement tube 570 helps rotate the first pivot fork 310 about the first vertical column 210. For example, drawing hydraulic fluid 550 within the cylinder 530 can rotate clockwise, while withdrawing hydraulic fluid 550 from the cylinder 530 can rotate the first pivot fork 310 counterclockwise.

### Affixing the Vertical Column

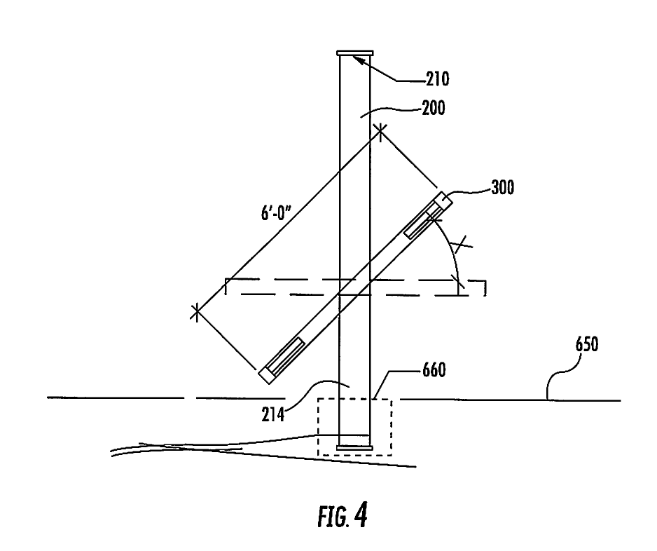

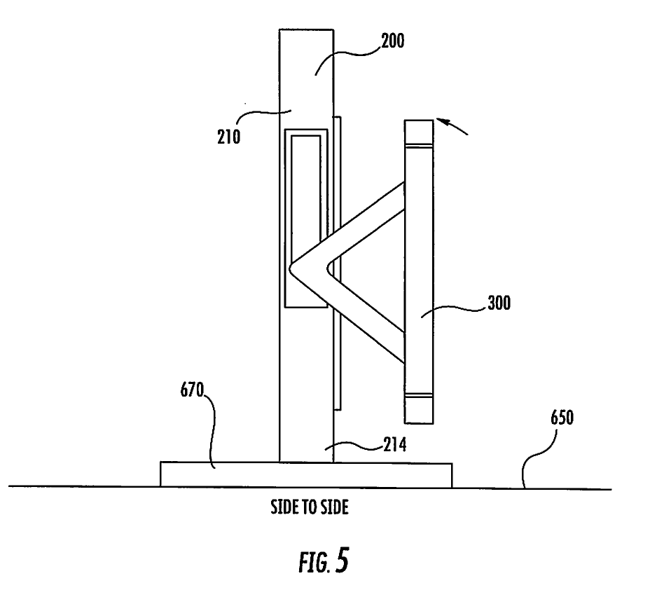

FIG. 4 and FIG. 5 both offer two separate ways to affix each vertical column 200 to the garage floor 650. FIG. 4 illustrates, by way of example, a first way to affix a vertical column 200. As shown, one manner of affixing includes inserting the bottom end 214 of a vertical column 200 within the garage floor 650. Under this system, an adhesive layer 660 is created around the bottom end 214 to create a stable seal with the garage floor 650. While this adhesive layer 660 can be a variety of materials, it is preferably concrete or aggregate.

FIG. 5 illustrates, by way of example, an alternative way to secure each vertical column 200. As shown, a horizontal stabilizing bar 670 can be affixed to the bottom end 214 of each vertical column 200. Such stabilizing bar 670 is perpendicular to the vertical column 200. Optionally, the stabilizing bar 670 can be affixed to the garage floor 650 through an adhesive 670.

### The Positioning Vehicle

While FIG. 4 and FIG. 5 illustrate ways to affix the vertical column 200 onto the garage floor 650, the invention further contemplates a positioning vehicle 700 which allows the vertical column 200 to be positioned to lift the automobile 600. This allows each vertical column 200 to be positioned below the automobile 600 prior to lifting above the garage floor 650. Both FIGS. 6A and 6B illustrate, by way of example, one embodiment of the positioning vehicle 700. First turning to FIG. 6A, the positioning vehicle 700 may include spring loaded wheels 710, an engaging handle 720 which attaches to a vertical control shaft 730, a plurality of pivot bars 740, and an essentially “U” shaped brace 750. One of ordinary skill in the art, through review of FIGS. 6A and 6B will recognize similar assemblies for the positioning vehicle 700.

Specifically, FIG. 6A illustrates the positioning vehicle 700 (positioned at the bottom end 214 of the vertical column 200) when not engaged with the automobile 600. The first component is the engaging handle 720. Such engaging handle 720 has a first end 721, middle portion 722, and second end 723. The first end 721 is capable of including a grip 725. Positioned on the second end 723 is a stationary pivot point 724 positioned near the bottom end 214 of the vertical column 200. Positioned proximate the middle portion 722 is a vertical control shaft 730. While the engaging handle 720 is pressed downward, the vertical control shaft 730 is pushed downward, causing rotation of the second end 723 about the stationary pivot point 724.

Affixed to the distal end 731 of the vertical control shaft 730 is the first spring action wheel 711. The first spring action wheel 711 includes a flat plate 712, and a wheel joist 713 positioned perpendicular to the flat plate 712. The flat plate 712 is attached to a first pivot bar 741. When the engaging handle 720 is pressed, this turns the flat plate 712 to cause the first spring action wheel 711 to fall within the “U” shaped brace 750 (thus causing the positioning brace 700 to affix to the garage floor 650).

In direct communication is a second pivot bar 742, which engages and turns a third pivot bar 743. As shown in FIG. 6B, the third pivot bar 743 is in direct communication with the second spring action wheel 713. As shown, when the engaging handle 720 is pressed this causes the third pivot bar 743 to cause the second spring action wheel 714 to fall within the “U” shaped brace 750 of the positioning vehicle. A similar series of pivot bars 742 and 743 help similarly engage a third spring action wheel 715 (not shown).

Such a system allows a mechanic or service technician with a sufficient level of time to inspect and gain access to the underside of the automobile. Moreover, such a design is universally feasible to engage all types of commercially available automobiles.

### Method of Lifting and Tilting an Automobile

The invention is further directed to a method of lifting and tilting an automobile 600 for purposes of maintenance and repair. The method starts with the step of vertically raising a pivot fork 300 about a vertical column 200 having a shaft 211, middle portion 213 and a rotation cavity 217 proximate to the middle portion 213. Here, each pivot fork 300 includes a first holding beam 331 and a corresponding second holding beam 332 in parallel relationship to one another.

Each pivot fork 300 may further include a connecting beam 335 which attaches the first holding beam 331 to the second holding beam 332, wherein the connecting beam 335 connects to the vertical column 200 through a rotating beam 339 positioned within the rotation cavity 217. The second step includes rotating the rotating beam 339 of the pivot fork 300 either clockwise or counterclockwise about the rotation cavity 217 of the vertical column 200 through a hydraulic pump 500 capable of inserting or retracting hydraulic fluid 550 to effectuate rotation.

That which is claimed:

1. A hydraulic tilt lift assembly, comprising:
at least one vertical column having a shaft, a middle portion and a rotation cavity proximate the middle portion;
a pivot fork perpendicularly connected to each vertical column, the pivot fork having a first holding beam and corresponding second holding beam in parallel relationship to one another, the pivot fork further including a connecting beam which attaches the first holding beam to the second holding beam, wherein the connecting beam connects to the vertical column through a rotating beam positioned within the rotation cavity; and
at least one fastener positioned on a first holding beam for affixing the automobile to the hydraulic tilt lift; and
a hydraulic pump.

2. A hydraulic tilt lift assembly of claim 1, further comprising:
a first vertical column;
a second vertical column; and
a first pivot fork attached to the first vertical column; and
a second pivot fork attached to the second vertical column.

3. A hydraulic tilt lift assembly of claim 2, wherein the first pivot fork includes a first fastener positioned on the first holding beam and a second fastener positioned on the second holding beam, both the first and second fasteners each having parallel engaging bars of sufficient size and dimension to engage each tire of the automobile.

4. A hydraulic tilt lift assembly of claim 1, wherein each pivot fork includes a vertical connector positioned between the connecting beam and the rotating beam.

5. A hydraulic tilt lift assembly of claim 3, wherein the first fastener includes a “Y” tether having a first tether portion and a second tether portion sufficient to secure each tire of the automobile onto the parallel engaging bars.

6. A hydraulic tilt lift assembly of claim 3, wherein the second fastener includes a “Y” tether having a first tether portion and a second tether portion sufficient to secure each tire of the automobile onto the parallel engaging bars.

7. A hydraulic tilt lift assembly of claim 1, wherein the hydraulic pump includes an outer cylinder filled with hydraulic fluid, a piston positioned within the outer cylinder, a first fluid disbursement tube, and a second fluid disbursement tube.

8. A hydraulic tilt lift assembly of claim 7, wherein the first fluid disbursement tube supplies a sufficient amount of hydraulic fluid to vertically raise and lower the pivot fork while the second fluid disbursement tube pivots the pivot fork either clockwise or counterclockwise about the vertical column.

9. A hydraulic tilt lift assembly of claim 1, further comprising a positioning vehicle which includes at least one spring loaded wheel that is engaged by a vertical control shaft operated by an engaging handle.

10. A hydraulic tilt lift assembly of claim 9, wherein the positioning vehicle further includes a “U” shaped brace is rests upon the garage floor upon engaging the handle to pivot the vertical control shaft.

11. A method of lifting and rotating an automobile, comprising the steps of:
(a) vertically raising a pivot fork about a vertical column having a shaft, middle portion and a rotation cavity proximate to the middle portion, wherein each pivot fork includes a first holding beam and corresponding second holding beam in parallel relationship to one another, the pivot fork further including a connecting beam which attaches the first holding beam to the second holding beam, wherein the connecting beam connects to the vertical column through a rotating beam positioned within the rotation cavity; and
(b) rotating the rotating beam of the pivot fork either clockwise or counterclockwise about the rotation cavity of the vertical column through a hydraulic pump capable of inserting or retracting hydraulic fluid to effectuate rotation.

12. The method of claim 11, wherein the first pivot fork includes a first fastener positioned on the first holding beam and a second fastener positioned on the second holding beam, both the first and second fasteners each having parallel engaging bars of sufficient size and dimension to engage each tire of the automobile.

13. The method of claim 11, wherein each pivot fork includes a vertical connector positioned between the connecting beam and the rotating beam.

14. The method of claim 12, wherein the first fastener includes a “Y” tether having a first tether portion and a second tether portion sufficient to secure each tire of the automobile onto the parallel engaging bars.

15. The method of claim 12, wherein the second fastener includes a “Y” tether having a first tether portion and a second tether portion sufficient to secure each tire of the automobile onto the parallel engaging bars.

16. The method of claim 11, wherein the hydraulic pump includes an outer cylinder filled with hydraulic fluid, a piston positioned within the outer cylinder, a first fluid disbursement tube, and a second fluid disbursement tube.

17. The method of claim 16, wherein the first fluid disbursement tube supplies a sufficient amount of hydraulic fluid to vertically raise and lower the pivot fork while the second fluid disbursement tube pivots the pivot fork either clockwise or counterclockwise about the vertical column.

18. The method of claim 11, wherein the a positioning vehicle is attached to the bottom end of each vertical column, the positioning vehicle including at least one spring loaded wheel that is engaged by a vertical control shaft operated by an engaging handle.

19. The method of claim 18, wherein the positioning vehicle further includes a “U” shaped brace is rests upon the garage floor upon engaging the handle to pivot the vertical control shaft.
